(19) United States
(12) Patent Application Publication
(10) Pub. No.: US 2026/0196184 A1
(43) Pub. Date: Jul. 9, 2026

(54) EXTERNAL COMPONENT CHARACTERISTIC CONTROL

(71) Applicant: Lenovo Global Technology (United States) Inc., Morrisville, NC (US)

(72) Inventors: Nathan Peterson, Oxford, NC (US); John C. Mese, Cary, NC (US); Mark Delaney, Raleigh, NC (US); Diana Gerli, Raleigh, NC (US); Robert James Norton, JR., Raleigh, NC (US)

(21) Appl. No.: 19/011,019

(22) Filed: Jan. 6, 2025

(51) Int. Cl. G09G 5/00

(52) U.S. Cl. CPC G09G 5/006; G09G 2370/042

(57) ABSTRACT

One embodiment provides a method, the method including: detecting, using an external component control system, input provided at an input element of a device, wherein the input element is configured to control a characteristic of a display component of the device; determining, using the external component control system, that the characteristic of an external display component is to be controlled by the input; and transmitting, based upon the input provided to the input element, instructions to control the characteristic of the external display component. Other aspects are claimed and described.

### BACKGROUND

Many users utilize devices in different locations. Accordingly, the form factor of devices has changed so as to allow greater portability. For example, devices have gotten smaller in size and weight, components that were once common in or on devices have been removed (e.g., stands, media readers, full-sized keyboards or input devices, etc.), and/or the like. While allowing for greater portability, the portable form factor may result in devices that are easier to carry and move around, the same portable form factor may be detrimental when a user is attempting to utilize the device in a traditional environment. For example, while a touch screen may be a useful input component when a tablet is being carried around, if the tablet is being used on a table or desk, having to provide input at the touch screen may not be the most efficient or conducive to a good user experience. Accordingly, many external components have been produced that allow a user to connect an external component to a device. The device is still portable, but if it is being used in a traditional environment, the device can be connected to the external components, thereby allowing the user to interface with the device in a manner which is most comfortable and most efficient for the user.

### BRIEF SUMMARY

In summary, one aspect provides a method, the method including: detecting, using an external component control system, input provided at an input element of a device, wherein the input element is configured to control a characteristic of a display component of the device; determining, using the external component control system, that the characteristic of an external display component is to be controlled by the input; and transmitting, based upon the input provided to the input element, instructions to control the characteristic of the external display component.

Another aspect provides a system, the system including: a device including an input element; an external display component; a processor; a memory device that stores instructions that, when executed by the processor, causes the system to: detect, using an external component control system, input provided at the input element of the device, wherein the input element is configured to control a characteristic of a display component of the device; determine, using the external component control system, that the characteristic of the external display component is to be controlled by the input; and transmit, based upon the input provided to the input element, instructions to control the characteristic of the external display component.

A further aspect provides a product, the product including: a computer-readable storage device that stores executable code that, when executed by a processor, causes the product to: detect, using an external component control system, input provided at an input element of a device, wherein the input element is configured to control a characteristic of a display component of the device; determine, using the external component control system, that the characteristic of an external display component is to be controlled by the input; and transmit, based upon the input provided to the input element, instructions to control the characteristic of the external display component.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method for controlling a characteristic of an external component utilizing an input element of a device by determining that the external component is to be controlled by the input component and not a component of the device.

### DETAILED DESCRIPTION

While connecting external components to a device is very useful to a user, interfacing with the external components may not be very straightforward. In other words, changing characteristics of an external component when connected to a device is not very straightforward. A device usually has an input element (e.g., button, switch, key, etc.) that allows for the adjustment of characteristics of components of the device.

However, adjusting the same characteristic of an external component requires the user to utilize input elements on the external component. For example, if a user wants to change the brightness of a display of a laptop, the laptop device usually has a button that allows for the user to provide input at the button and the brightness of the laptop display is adjusted.

However, if the user wants to change the brightness of an external display that is connected to or in communication with a device, the user typically has to identify the input element on the display and traverse the display menu to be able to change the brightness. The user then has to determine what input elements on the display that need to be actuated in order to actually change the brightness. Providing input to the incorrect input element can result in the user exiting the display menu and having to start over. Additionally, external components usually have different input elements and menus as compared to other external components, even those of the same component type or produced by the same manufacturer. Thus, trying to determine how to change a characteristic of the external component can be difficult, time-consuming, and frustrating for a user. Additionally, it is a new experience for every external component that the user may encounter, meaning the user has to figure out the process for an external component every time due to the difference in external components.

Some external components can be controlled using input elements on the device. However, in many instances it is not a true control of the external component, but rather an output value of the output is being modified which makes it seem like the external component is being controlled. For example, a volume of audio being outputted from an external speaker can seemingly be controlled using an input element of a device. However, in many instances it is not the output volume of the external speaker itself that is being controlled, but rather what is being controlled is a power setting or level for the audio output of the device that is provided as input to the external speaker. Thus, the audio volume increases or decreases through the external speaker, but it is actually the output signal of the audio that is being changed and not the volume setting on the speaker itself. Other output mediums cannot be controlled in a similar manner. For example, changing the brightness of a monitor cannot be accomplished by modifying a characteristic of a video output signal.

Accordingly, the described system and method provides a technique for controlling a characteristic of an external component utilizing an input element of a device by determining that the external component is to be controlled by the input component and not a component of the device. The external component control system detects input provided at an input element of a device. The input element is configured to control a characteristic of a component of the device. The input provided at the input element may be current input that has been provided at the input element or may be input that was previously provided at the input element. Current input refers to input that is provided during a session that an external component was connected to the device. For example, a user may connect an external component to a device. The user may then provide input at the input element. Alternatively, in a previous session, the user may have provided input at the input element. When the external component is connected at a subsequent session, this previously provided input may be detected in response to the connection to the external component.

The external component control system may then determine that the input is to be used to control the external component. To make this determination the external component control system may identify that the external component is being as a primary component as compared to the component of the device. In other words, the external component control system may determine that the device has an integral component and at least one external component of the same component type. The system may then determine that the user is utilizing the external component(s) as the primary component of that type as opposed to the component integral to the device. The external component control system can also use other techniques to determine that the input is to be used to control the external component, for example, focus identification, gaze tracking, active component identification, and/or the like. Once the external component control system has determined that the input is to control the external component, the external component control system transmits instructions to control the characteristic of the external component. In other words, the system will control the characteristic of the external component over the characteristic of the component of the device.

Therefore, a system provides a technical improvement over traditional methods for controlling characteristics of external components. Instead of a user having to determine how to control characteristics of external components using the input elements provided on the external component, the user is able to use an input element on the device to control the characteristic of the external component. Thus, instead of the frustrating and time-consuming process that a user has to undertake to change the characteristic of the external component, the user can easily make the desired adjustments without having to determine what process needs to be undertaken to do so. Additionally, instead of the input elements that are on the device only being able to control the components of the device, the input elements are more universally usable, thereby allowing for greater usability for input elements that are taking up space on the device. Accordingly, the described system and method provides a technique that is more user friendly, more efficient, and less frustrating than traditional techniques in which input elements can only be used to control components integral to the input element.

The illustrated example embodiments will be best understood by reference to the figures. The following description is intended only by way of example, and simply illustrates certain example embodiments.

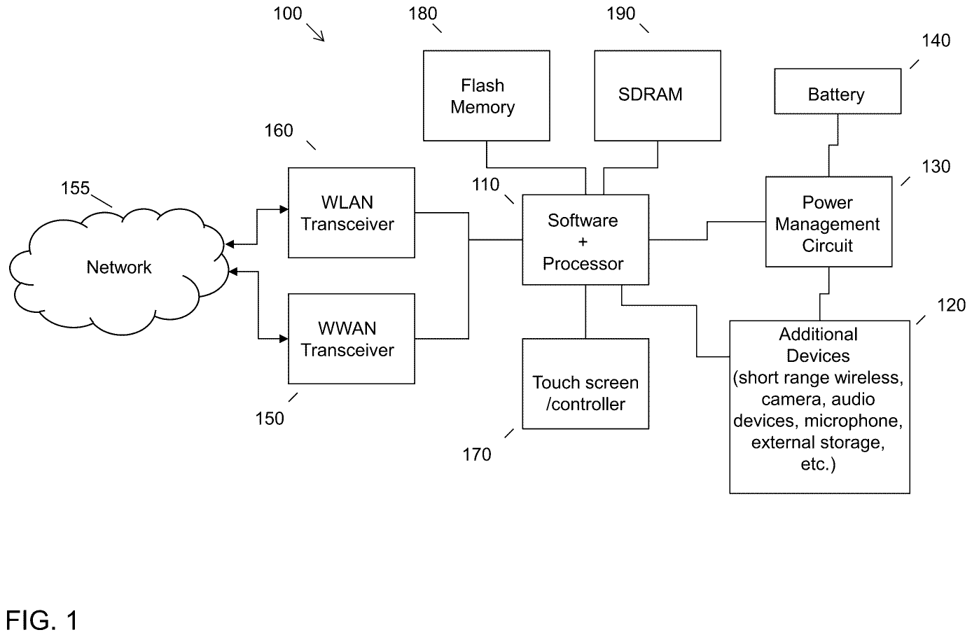

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, input/output (I/O) ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use serial advanced technology attachment (SATA) or peripheral component interconnect (PCI) or low pin count (LPC). Common interfaces, for example, include secure digital input/output (SDIO) and inter-integrated circuit (I2C).

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply basic input/output system (BIOS) like functionality and dynamic random-access memory (DRAM) memory.

System 100 typically includes one or more of a wireless wide area network (WWAN) transceiver 150 and a wireless local area network (WLAN) transceiver 160 for connecting to various networks 155 (e.g., telecommunications networks, wireless Internet devices (e.g., access points), cloud networks, remote networks, local networks, etc.). Additionally, devices 120 are commonly included, e.g., a wireless communication device, external storage, camera, microphone, external storage, etc. System 100 often includes a touch screen 170 for data input and display/rendering. System 100 also typically includes various memory devices, for example flash memory 180 and synchronous dynamic random-access memory (SDRAM) 190.

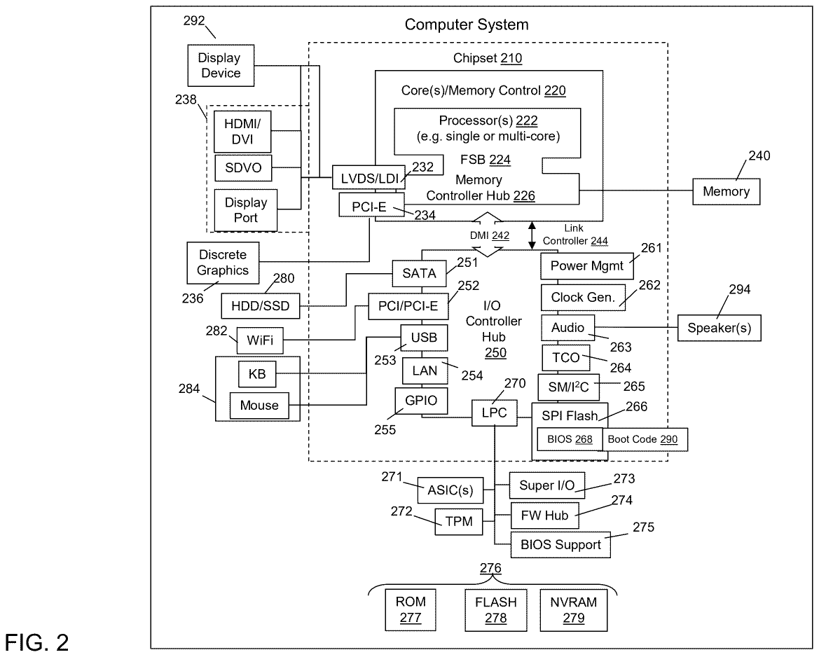

FIG. 2 depicts a block diagram of another example of information handling device circuits, circuitry, or components. The example depicted in FIG. 2 may correspond to computing systems such as personal computers, or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of random-access memory (RAM) that may be referred to as “system memory” or “memory”). The memory controller hub 226 further includes a low voltage differential signaling (LVDS) interface 232 for a display device 292 (for example, a cathode-ray tube (CRT), a flat panel, touch screen, etc.). A block 238 includes some technologies that may be supported via the low-voltage differential signaling (LVDS) interface 232 (for example, serial digital video, high-definition multimedia interface/digital visual interface (HDMI/DVI), display port). The memory controller hub 226 also includes a PCI-express interface (PCI-E) 234 that may support discrete graphics 236.

In FIG. 2, the I/O hub controller 250 includes a SATA interface 251 (for example, for hard-disc drives (HDDs), solid-state drives (SSDs), etc., 280), a PCI-E interface 252 (for example, for wireless connections 282), a universal serial bus (USB) interface 253 (for example, for devices 284 such as a digitizer, keyboard, mice, cameras, phones, microphones, storage, other connected devices, etc.), a network interface 254 (for example, local area network (LAN)), a general purpose I/O (GPIO) interface 255, a LPC interface 270 (for application-specific integrated circuit (ASICs) 271, a trusted platform module (TPM) 272, a super I/O 273, a firmware hub 274, BIOS support 275 as well as various types of memory 276 such as read-only memory (ROM) 277, Flash 278, and non-volatile RAM (NVRAM) 279), a power management interface 261, a clock generator interface 262, an audio interface 263 (for example, for speakers 294), a time controlled operations (TCO) interface 264, a system management bus interface 265, and serial peripheral interface (SPI) Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices such as tablets, smart phones, personal computer devices generally, and/or electronic devices, which may be devices which are utilized to connect to external components, house or provide access to the external component control system, and/or the like. For example, the circuitry outlined in FIG. 1 may be implemented in a tablet or smart phone embodiment, whereas the circuitry outlined in FIG. 2 may be implemented in a personal computer embodiment.

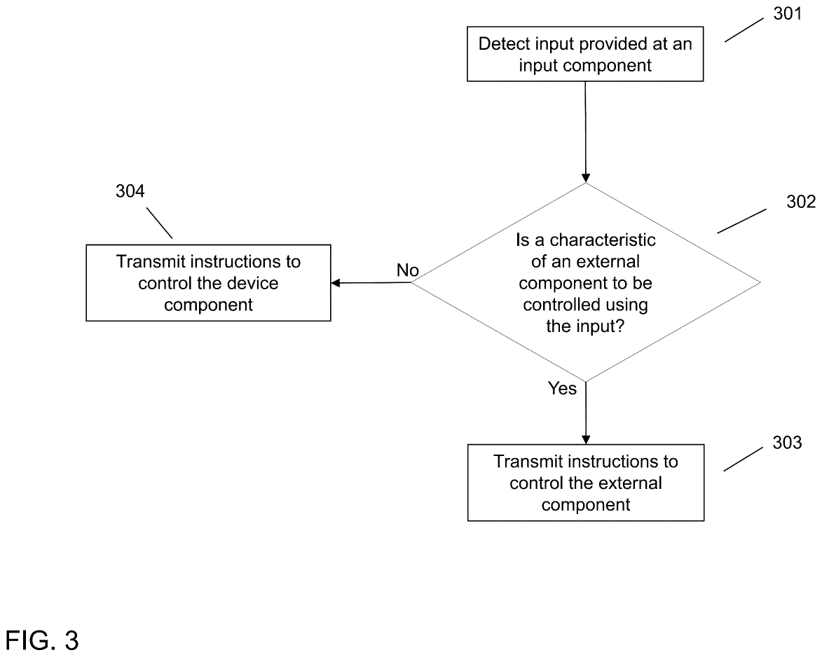

FIG. 3 illustrates an example method for controlling a characteristic of an external component utilizing an input element of a device by determining that the external component is to be controlled by the input component and not a component of the device. The method may be implemented on a system which includes a processor, memory device, output devices (e.g., display device, printer, etc.), input devices (e.g., keyboard, touch screen, mouse, microphones, sensors, biometric scanners, etc.), image capture devices, and/or other components, for example, those discussed in connection with FIG. 1 and/or FIG. 2. While the system may include known hardware and software components and/or hardware and software components developed in the future, the system itself is specifically programmed to perform the functions as described herein to control a characteristic of an external component utilizing an input element of a device. Additionally, the external component control system includes modules and features that are unique to the described system.

The external component control system may be activated in order to determine that an external component is to be controlled by input provided to an input element of a device. Thus, the external component control system may be activated upon detection of the connection of an external component to a device. The system can then determine if input provided at an input element of a device is intended for a component of the device or the external component. Once the external component control system determines if the input provided is intended to change a characteristic of a component of the device or a characteristic of an external device, the system can transmit instructions to control the characteristic of the determine component, whether that be the external component or a component of the device.

Activation of the external component control system may be a manual activation of the external component control system and/or an automatic activation of the external component control system. Manual activation of the system may include a user opening an application associated with the external component control system, the user accessing the computing system associated with the external component control system, and/or the user otherwise providing input to the external component control system. The automatic activation of the external component control system may be based upon the detection of a trigger event indicating that the system should be activated. Example trigger events include the user connecting an external component to a device, detection of an input being provided at an input element, a user accessing an application that interfaces with the external component control system, activation of software or an application utilizing the external component control system, and/or the like.

The external component control system may be made of multiple systems or modules that communicate together to make up the external component control system or may be a single system. The external component control system may be a standalone system, may be accessible through other computing devices, and/or a combination thereof. For example, the external component control system may be a standalone system that can be accessed by a user and/or may be or provide an application that is accessible by a user on another computing device. The external component control system may be accessible using any type of computing device, for example, personal computer, laptop computer, smartphone, tablet, smartwatch, head-mounted display, smart television or other smart appliance, augmented reality device, virtual reality device, and/or the like. Thus, the external component control system may be accessible locally using a computing device where the external component control system is installed and/or may be accessible remotely through another computing device. For example, the external component control system may be accessed by a user using a device that communicates with the external component control system to detect input provided at an input element of a device, determine that the characteristic of an external display component is to be controlled by the input, transmit instructions to control the characteristic of the external component, and/or the like. However, the external component control system may be located and operate on a different information handling device to perform the described steps.

The external component control system may have an associated graphical user interface. The graphical user interface may be provided on a display or monitor, which may or may not be associated with the external component control system. In other words, the external component control system may have a dedicated display or monitor or may be accessible using any display or monitor. In either case, the external component control system may provide instructions to generate and display the graphical user interface on the display device being used to access the external component control system. The graphical user interface may also be updated and managed based upon instructions provided by the external component control system. In other words, the external component control system generates and transmits instructions to create and update the graphical user interface.

The graphical user interface may include a plurality of tabs, windows, and/or unique interfaces. The graphical user interface may include graphical user interface icons or elements. Graphical user interface icons or elements may include static non-selectable elements (e.g., headers, footers, logos, global information areas, graphics, etc.), dynamic non-selectable elements (e.g., local information areas applying to a specific element, dynamic graphics, information areas that update based upon the information provided therein, indicators, statistics displays, etc.), static selectable elements (e.g., radio buttons, menu icons, selectable indicators, etc.), dynamic selectable elements (e.g., form field input areas, pull-down menus, pop-up windows, etc.), and/or any other elements that may be found in a graphical user interface.

The graphical user interface may allow a user to provide input identifying information to be used by the external component control system. For example, the external component control system may utilize a user profile, historical information, and/or the like, to determine that a characteristic of an external component is to be controlled by input provided at an input element, transmit instructions to control the characteristic, and/or the like. The graphical user interface may allow for creation of or access to these profiles, historical information, and/or the like, by allowing a user to input information regarding user preferences, device information, and/or the like. As will be discussed in more detail, the use of user provided information is not the only way that the profile and/or historical information can be created. The external component control system can then utilize these inputs, whether provided directly by the user or identified using a different technique, to create the profile(s), store the historical information, and/or the like.

A user could also use the graphical user interface to adjust information within the profile(s), historical information, and/or the like. Additionally, or alternatively, the user can input a location of information related to one or more of the profiles, historical information, and/or the like, provide a file corresponding to information related to the information, and/or the like, within the graphical user interface. Input may be provided by the user using any type of input modality, including, but not limited to, mechanical input (e.g., keyboard input, mouse input, etc.), touch input, audible or voice input, gesture input, haptic input, thought input, and/or the like.

The graphical user interface may also provide displays that display information of the profiles, and/or the like. It should be noted that the information to be used by the external component control system and information provided by the external component control system can be different for different applications, different computing systems, different users, and/or the like. Thus, the information corresponding to input or output of the external component control system are not always the same. However, the external component control system may have default or system-wide settings that are the same across different users, systems, applications, and/or the like, until the information is adjusted or otherwise changed.

It should be noted that different users may configure the graphical user interface per their preferences. Thus, the graphical user interface layout and configuration may be different between users. How much a user can configure the layout may be restricted or set by a system administrator and/or the like. Additionally, different users or different user roles may have different levels of access, which may also change how and what information is displayed. Thus, different graphical user interfaces may be displayed by the system.

The external component control system may utilize one or more artificial intelligence models in detecting an input provided at an input component and determining if the input is to control a characteristic of an external component. Artificial intelligence models could be designed to perform the detection of the input provided at an input element of a device, the determination that the characteristic of an external display component is to be controlled by the input, transmission of the instructions, or any other steps within the described system. Artificial intelligence models may also be used for steps within a step. For example, a model could be utilized to detect a focus of a user to determine that the characteristic of an external component should be controlled, detect that the external component is the primary component to determine that the characteristic should control the characteristic of an external component, determine which of multiple external components of the same type should be controlled by input, analyze a user profile to detect an input, analyze a plurality of user profiles to detect an input, generate instructions to be transmitted to a component, and/or the like.

For ease of readability, the majority of the description will refer to a single artificial intelligence model. However, it should be noted that an ensemble of artificial intelligence models or multiple artificial intelligence models may be utilized. Additionally, the term artificial intelligence model within this application encompasses neural networks, machine-learning models, deep learning models, artificial intelligence models or systems, and/or any other type of computer learning algorithm or artificial intelligence model that may be currently utilized or created in the future.

The artificial intelligence model may be a pre-trained model (e.g., a general model, such as a general classification model) that is fine-tuned for the external component control system, or the artificial intelligence model may be a model that is created and trained from scratch. Since the external component control system is used in conjunction with detecting input and determining for which component to control the characteristic, some models that may be utilized by the system are image analysis models, text analysis models, audio analysis models, analysis models, similarity identification models, language models, large language models, entity identification models, input analysis models, filtering models, classification models, and/or the like. The model may be trained using one or more training datasets. Additionally, as the model is deployed, it may receive feedback to become more accurate over time. Alternatively, or additionally, the model may utilize inputs provided to the model to learn continually, thereby using the inputs to make subsequent predictions or using the inputs within the subsequent predictions. The feedback or inputs may be automatically ingested by the model as it is deployed. For example, as the model is used to perform the described method, if a user modifies predictions that were made by the model, provides feedback regarding a prediction, or otherwise provides some indication that the predictions or selections made by the model may be incorrect, the model may ingest this feedback to refine the model.

On the other hand, as the model makes predictions in connection with performing the described steps, and no changes are made to the resulting prediction, the model may utilize this as feedback to further refine the model. This may be referred to as reinforcement training where a prediction that was made by the model is reinforced as the correct prediction. Training the model may be performed in one of any number of ways including, but not limited to, supervised learning, unsupervised learning, semi-supervised learning, training/validation/testing learning, and/or the like.

The feedback or inputs could be stored within a data store and utilized at a later time to train or retrain the model. For example, a user could use the feedback to update a training dataset to train or retrain the model. The feedback or inputs could also be stored within the data store and then be used by the model for updated training. This may be done, for example, in an unsupervised learning session that allows the model to learn patterns and information regarding the training dataset without the need for human supervision, thereby providing at least a partially automated technique for the model to become updated. However, the model may or may not perform this retraining without a human providing input to the model to perform the retraining. In other words, retraining of the model may be based upon how the model is programmed and whether the model is updated while it is deployed or is only updated during a training mode may be based upon that programming.

As previously mentioned, an ensemble of models or multiple models may also be utilized. Some example models that may be utilized are variational autoencoders, generative adversarial networks, recurrent neural networks, convolutional neural networks, deep neural networks, autoencoders, random forest, decision tree, gradient boosting machine, extreme gradient boosting, multimodal machine learning, unsupervised learning models, deep learning models, transformer models, inference models, and/or the like, including models that may be developed in the future. The chosen model structure may be dependent on the particular task that will be performed with that model.

The external component control system may include different components for carrying out different functions of the system, including different steps to be performed. These components may be hardware components or software components.

Some hardware devices or components that may be utilized by the external component control system include input devices that may be utilized to receive input from the user, for example, mechanical input modalities (e.g., keyboard, mouse, etc.), touch input devices, gesture input devices, electromyography input devices, audio input devices, and/or the like. Other hardware components may be utilized to provide output from the external component control system. For example, the external component control system may include speakers, displays or monitors, haptic output devices, audio output devices, and/or the like. Other hardware components may be included to capture images, for example, an image capture device, screen capture devices, and/or the like. Other hardware components may include data storage devices, including on devices of the user (e.g., mobile device, personal computer, laptop, tablet, smart watch, etc.), devices or components of the external component control system, and/or the like.

One software component may include a data storage location or data repository that stores information related to component characteristics, user profiles, and/or the like. The data storage location or data repository may also store information related to components, for example, identifiers, models, types, manufacturers, serial numbers, and/or the like. Information may be stored in the data storage location using any data storage technique. Additionally, the system can access the information stored within the data storage location using any type of querying technique, filtering technique, and/or the like. The information contained within the data storage location may also be organized, for example, grouped by component type, grouped by user, grouped by input elements, and/or the like.

Another software component includes a user profile that stores information related to a user and user preferences. The external component control system may utilize information contained within a user profile to detect an input and/or determine that the characteristic of an external component is to be controlled by an input. Thus, the user profile may include information related to external components and characteristic settings for the external components that the user prefers. This information may be identified by the user through manual input, or, more likely, identified by the external component control system as the user makes changes to characteristics of components. Thus, the external component control system can monitor inputs provided by a user at both a device and also at external components. Once the user has provided inputs to modify characteristics of components, the external component control system can store this information or settings within the user profile.

The external component control system may also extrapolate characteristic settings for components that the user has not yet provided inputs to control the characteristics. To do this, the external component control system may have access to information within the user profile, may have access to information from profiles of other users, may have access to information related to components, and/or the like.

Accordingly, the user profile or other profiles may contain any information that would allow the system to detect that an input was provided at an input component, determine that a characteristic of an external component is to be controlled by the input, determine the setting to which to adjust the characteristic, and/or the like.

In inferring or correlating characteristic settings, detecting input provided at an input device, determining that a characteristic of an external component is to be controlled by the input, and/or the like, the system may utilize one or more techniques that allows for the inference or identification of information including, but not limited to, rules engines, artificial intelligence models, correlation techniques, and/or the like. These techniques may take the identified information as input, analyze that input based upon the technique programming, and provide an output related to the desired information. This information may then be placed within the user profile for later access.

The user profile may also contain other information, for example, information related to preferences of the user. For example, the user profile may include information related to when the external component control system should detect an input provided at an input element, determining whether the input should control a characteristic of an external component, and/or the like. Any of the mentioned profiles, or other profiles, may include additional information that may be useful for the external component control system and may be entered by a user, may be default values, may be learned by the system over time, and/or the like. Thus, profiles can be populated with information manually by a user, entities or companies, and/or the like, or can be populated over time as the system learns more about the user, models, entities or companies, and/or the like. For example, a user may manually provide input to a user profile and the system can learn preferences about the user over time and populate the user profile with this learned information.

Learned information may be information learned based upon direct inputs, for example, a user may be presented with a pop-up window in response to a trigger and provide input to the pop-up window. This input can be then populated into the user profile. Learned information may also be information learned based upon indirect inputs, for example, a user may provide inputs (e.g., audible inputs, visual inputs, gesture inputs, etc.) that indicate that the user would like to control a characteristic of an external device, and/or the like. The system can then aggregate this information to learn preferences of the user. Similarly, the system can learn information for other profiles. With respect to the described external component control system, the learned information may include historical information, determinations of when inputs should control external devices, and/or the like.

At 301, the external component control system detects input provided at an input element of a device. The input element is an input element that is configured to control a characteristic of a component of the device. The example used here throughout will be the example of a display device. However, other devices could be utilized and this is not intended to limit this system and method to only a display device. For ease of readability, the component of the device may also be referred to as the device component and refers to the component of the device that is integral to the form factor of the device. For example, a display screen of a laptop device would be a device component, whereas a monitor connected to a port of the device would be an external device. As another example, an internal device speaker would be a device component, whereas a speaker wirelessly connected to the device would be an external device. Thus, a device component refers to a component that is included during manufacture of the device (even if subsequently replaced), whereas an external component is a component that is connected to the device through a communication connection, for example, a wired connection, a wireless connection, and/or the like, or a combination thereof.

The input element may be an input element that is configured to only perform the function of controlling the characteristic of a display component of the device, or may be an input element that is configured to perform multiple functions. For example, the input element could be a button, switch, key, soft key, and/or the like, that only performs the function of controlling a characteristic of a component of the device. As another example, the input element could be a button, switch, key, and/or the like, that performs the function of controlling a characteristic of a component of the device and also performs another function. To perform the desired function for a multi-function input element, the user may have to provide input at multiple input elements, for example, input at a modifier input element in addition to input at the input element, input of another modality in addition to input at the input element, and/or the like.

While the input element being a key on a keyboard will be used as the example here throughout for ease of readability, it should be understood that the input element could be any type of input element and is not narrowed to only a key on a keyboard. For example, buttons on a mouse could be utilized as the input element, gestures on a trackpad could be utilized as the input element, and/or the like. Additionally, inputs using modalities other than touch or mechanical input can be utilized, for example, audible input, gesture input, movement of the device itself, haptic input, electromyography input, and/or the like.

Different input elements may be provided that allow for the control of different characteristics of a component. Different components that may be controlled by an input element include, but are not limited to, a monitor or display device, an audio output device, an image capture device, an audio capture device, a device that reads or controls media (e.g., compact disc player, a secure digital card reader, a USB reader, a digital versatile disc (DVD) player, etc.), and/or the like. Accordingly, different characteristics that can be controlled may include, but are not limited to, display device brightness, display resolution, display scaling, display orientation, display color settings, audio output volume, media play control, image capture control, image capture settings (e.g., focus, tilt, crop, etc.), and/or the like.

In detecting an input provided at an input element of a device, the external component control system may determine if the device is connected to an external component. The connection may be any type of connection that allows transmission of signals and instructions for utilizing the external component. Accordingly, the connection may include, but is not limited to, a wired connection, a wireless connection (e.g., network connection, near field wireless connection, short range wireless connection, etc.), and/or the like, or a combination thereof. The external component control system may not be activated until an external component, or external components, are connected to the device. Thus, in this example, the detection of input by the external component control system may be responsive to the detection of a connection of the device to an external component or the detection of a communication connection between the device and an external component. Alternatively, the external component control system may be active at all times and may simply not determine if a characteristic of an external component is to be controlled unless an external component is actually connected to the device.

Additionally, the external component control system may identify a type of the external component that is connected. The type of the external component may refer to a class or function of the external component. Example component types include, but are not limited to, a display device, an audio output device, an audio capture device, an image capture device, a media control device, and/or the like. One reason for identifying the type may be to determine if the device already has a device component having the same type. If the device includes a device component of the same type as an external component, the external component control system may need to determine to which component (device or external) an input provided at an input element is to be directed.

On the other hand, if the device does not include a device component of the same type as an external component, the external component control system may determine that an input provided at an input element to control a characteristic of a component having a particular type should be directed to the external component by virtue of not having a device component characteristic that can be controlled using the input provided at the input element. Similarly, if the device is not connected to an external component that has a characteristic that is able to be controlled using the input provided at the input element, the external component control system may determine that the input should be directed to the device component.

The detection of the input may be detecting input that is provided during a current detection session or may be detecting input that was previously provided and then identified and utilized for the current detection session. A detection session will refer to a session that begins based upon the connection of or the detection of the connection of the external component to the device. The detection session ends when the connection to the external component is severed. The severing of the connection to the external component may include the external component being disconnected from the device, the device being placed into a power state where connections are not maintained, the external component being powered off, and/or any other event where the device is no longer communicating with the external component. Detecting the input provided during a current detection session may include a user provided input at the input element after the external component has been connected to, or is communicating with, the device.

The external component control system may also detect input during the current detection session where the input was provided during a previous detection session, either by the same user or other users. To perform this detection of the input, the system may utilize the user profile. The user profile may include information related to previous detection sessions with either the particular external component that has been connected during this detection session, an external component that has similar or the same specifications, and/or the like. The user profile may include information related to the specifications of external components (e.g., manufacturer, model, resolution, minimum and maximum characteristic settings, serial numbers, identifiers, names of the external component on a network, etc.) and may also include information related to settings that a user had set the characteristics for during a previous detection session. Using this information, the external component control system can determine the input to be used for the detection.

As a first example, the user is connecting to an external component that has been previously connected to by the user, either the exact external component or an external component having the same specifications as one to which the user has previously connected. Additionally, in the previous detection session, one or more characteristics of the external component were set to a value. This may include the user providing input at an input element or may include the user not providing input at an input element during the previous detection session. In other words, the user may have wanted to change the characteristic and, therefore, provided input at the input element of the device, or provided input at an input element of the external component. The final setting of the characteristic for the external component can be stored within the user profile. Alternatively, the user may have been satisfied with the setting for the characteristic of the external component once the external component was connected to the device and may not have provided input at an input element to change the characteristic setting. This setting can then be stored within the user profile as the final setting for the characteristic of the external component.

Thus, the final setting information can be stored within the user profile. When the user connects to the external component during a later detection session, the system can access the user profile. The external component control system can compare the current settings of the characteristics of the external component to the final settings contained within the user profile. Upon determining that a difference exists between the current settings of the external component and the final setting information contained within the user profile, the external component control system can provide input that is utilized as the detected input. This detected input will correspond to the final setting values for the characteristic for the external component.

As another example, a user may connect to an external component to which the user has not previously connected. However, the user may have connected to an external component that is of the same type as the external component to which the user is currently connecting. The external component to which the user has previously connected may have corresponding final setting information that has been stored within the user profile. The data repository that the external component control system can access may include information related to different specifications of different external components. Using this information, the external component control system can infer settings for the external component to which the user is currently connecting, even though the user has not previously connected to that external component or an external component having the same specifications.

Using an example of a display, the data repository may include information related to how many nits are produced by a particular display. For a display to which the user has previously connected (Display A in this example), the user profile may include the final brightness setting information for that display. For a display to which the user has not previously connected (Display B in this example), the data repository may include the nit information for that display. Based upon the final brightness setting information and the nit information for Display A, the external component control system can infer a desired brightness setting that a user would prefer for Display B. The external component control system can identify the output nits produced by Display A as the final brightness setting. Then, based upon the difference in nit production between Display A and Display B, the external component control system can infer or identify the brightness setting for Display B that would result in the same produced output nits as Display A for the final brightness setting. This inferred or identified brightness setting can then be treated as the detected input. It should be noted that this example is utilized for a display and a brightness characteristic of the display. However, a similar inference can be made for other characteristics or other component types.

As a final, non-limiting example, a user may connect to an external component to which the user has not previously connected. However, in this example, the external component control system utilizes profiles from other users to infer or identify the input for the external component. The user profile for the user may include information related to final settings for external components to which the user has previously connected. Profiles for other users may also include information related to final settings for external components to which those users have previously connected. Based upon final settings that the user and other users have utilized for the same external component, the external component control system can extrapolate a final setting for an external component to which the user has not previously connected but one of the other users has previously connected. This technique may be useful if the external component control system is unable to get specification information for an external component.

Using the display example, User A may have previously connected to Display A and the user profile for User A includes the final setting information for Display A. User B may also have previously connected to Display A and the user profile for User B includes the final setting information for Display A. User B may also have connected to Display B and the user profile for User B includes the final setting information for Display B. When User A connects to Display B, to which User A has not previously connected, the external component control system can infer the input from the correlation between User A's and User B's settings for Display A and User B's settings for Display B. In other words, the external component control system can identify the difference between settings of User A and User B for Display A. The external component control system can then apply this difference to User B's settings for Display B to get an inferred setting for User A for Display B. This inferred setting can then be treated as the detected input. It should be noted that this example is utilized for a display. However, a similar inference can be made for other characteristics or other component types.

These are merely example techniques for detecting an input that was provided in a previous detection session and are not intended to be limiting as other techniques for detecting an input that provided in a previous detection session are contemplated and possible. For example, the system can utilize user information to identify other users that are similar to the target user. Once those users are identified, the external component control system can identify the settings that have been made by those users and apply them to an external component to which the target user is connecting. As another example, the external component control system can request information from users identified as control users and then make extrapolations or inferences from the information provided by the control users. Other techniques are also contemplated.

At 302, the external component control system determines if a characteristic of an external component is to be controlled using the input. In other words, the external component control system determines whether the input detected at 301 is intended to control the device component or an external component. Additionally, since a user may be connected to more than one external component of the same type, the external component control system may determine which of the external components to which the input is directed, if the input is intended to control a characteristic of an external component. Accordingly, the external component may include components of any type as previously described, for example, a monitor or display device, an audio output device, an image capture device, an audio capture device, a device that reads or controls media (e.g., compact disc player, a secure digital card reader, a USB reader, a DVD player, etc.), and/or the like.

It should be noted that steps 301 and 302 could be reversed. In other words, the external component control system could detect the input to the input element first and then determine to which component (either device or external) the input is directed towards, or the system could determine which component is the component to which an input should be directed, and then detect the button push.

The device may have a corresponding device component. For example, a laptop may have a monitor. However, the user may want the input element of the device that controls component characteristics to control an external component and not the device component. In other words, under normal operation a component of a that can be controlled by an input element of the device will be controlled by the input element of the device even if the user is not attempting to adjust a characteristic of the device component. The described external component control system allows the user to utilize the input element of the device to control characteristics of an external component. Thus, the described external component control system expands the functionality of the input element that controls the characteristic of a device component to also allow control over characteristics of an external component. Accordingly, the external component control system needs to determine which component is intended to be controlled by the input provided at the input element.

To determine to which component the detected input is to control, the external component control system may use one or more techniques, some of which are described herein. However, it should be noted that other techniques for identify the target component are contemplated and possible. Accordingly, the described examples are not intended to be limiting.

Determining to which component the input is intended to control may first include identifying whether there are multiple components that are connected to the device, either as device components or external components, that have a characteristic corresponding to the input element. In other words, if the input element controls a characteristic and there is only a single component that has such a characteristic to be controlled, the external component control system may determine that the input is directed towards the component, regardless of whether it is a device component or an external component. However, if there are multiple components that are connected to the device that have a characteristic corresponding to the input element, the external component control system needs to discern to which component the input is to be directed.

One technique for identifying the component to which the input is to be directed is to identify which of the components the user is utilizing as the primary component of the component types. In other words, the external component control system may determine which of the components having the same component type is the primary component that the user is utilizing. The primary component may then be identified as the component that the input is being directed towards. Determining the primary component can be performed using one or more techniques. One technique may be the user identifying a particular component as being the primary component, for example, within a user profile, as learned by the system over time, based upon default settings, and/or the like. Another technique may be the external component control system monitoring the use of different components. The external component control system may then identify the component that is used a majority of the time, the component that is used more frequently than other components of the same type, the component that is most commonly used, and/or the like, as the primary component. Another technique may be the user providing an input, using any modality, identifying a particular component as a primary component. Other techniques for identifying or designating the primary component are contemplated and possible.

Another technique for identifying the component to which the input is to be directed is to identify a focus of the user and then identify the component that corresponds to the focus of the user. In other words, the external component control system may identify a focus of the user and then correlate that focus to a particular component. If the user is focused on a particular component and then the input is detected, the external component control system may then determine that it is that component the input should be directed towards. To identify the focus of the user, the external component control system may utilize any technique for identifying a focus of the user. For example, the external component control system may use a gaze tracking technique and compare a length of time of a gaze on a particular component to a threshold time that corresponds to a focus threshold. As another example, the external component control system may utilize a head tracking technique to determine a direction of the head of the user and correlate that direction with a particular component. Other techniques for determining a focus of a user are contemplated and possible.

Another technique for identifying the component to which the input is to be directed is to a component that is the active component. The active component may be identified using one or more techniques. One technique to identify the active component is to identify which component includes an active application. Using the example of a display component, the display component on which the active application window is contained may be considered the active component. Another technique to identify the active component is to identify the component for which an input device or input indicator is active. Using the example of the display component, the display component on which the mouse cursor is display may be considered the active component. Using an example of an audio output component, the audio output component that audio is being currently output may be considered the active component. Other techniques for determining an active component are contemplated and possible.

If the external component control system determines that the component for which the characteristic is to be controlled is the device component (no branch of 302), the external component control system may transmit instructions to control the characteristic at the device component at 304. This would result in the input element controlling the device component as per traditional techniques. In other words, the external component control system, or device, may transmit, based upon the input provided to the input element, instructions to control the characteristic of the device component.

If, on the other hand, the external component control system determines that the component for which the characteristic is to be controlled is the external component (yes branch of 302), the external component control system may transmit instructions to control the characteristic at the external component at 303. In other words, the external component control system may transmit, based upon the input provided to the input element, instructions to control the characteristic of the external component. Transmitting instructions to control the characteristic of the identified component may include transmitting instructions using whatever characteristic control instructions correspond to the component type. For example, display devices may be controlled using VPC codes. Thus, when controlling characteristics of display devices, the instructions may be in the form of VPC codes. Other component types may have other code types or other instruction types that are utilized to control those components. Accordingly, the instructions may be formatted in whatever format is necessary so that the component can understand the instructions being received from the external component control system.

In the event that the input is provided to the input element during the detection session, this input may be directed to the external component that was identified at 302. In the event that the input is provided to the input element during a previous detection session, the input may be identified form the previous detection session and then corresponding instructions may be transmitted to the external component. For example, if the input is identified from a user profile, transmitting the instructions may include generating instructions to adjust the characteristics of the external component to match the final setting included in the user profile. As another example, if the input is identified or inferred based upon correlations between information in the user profile or correlations between information contained in multiple user profiles, transmitting the instructions may include generating instructions to adjust the characteristic of the external component to match the inferred or otherwise identified setting.

It should be noted that the device may be connected to multiple external components having the same component type. Thus, in the event that the external component control system determines that the input is directed toward an external component, the system may also determine if the input is directed towards one, more than one, or all the external components of the same type. The external component control system may make this determination using any of the identification of component techniques discussed previously. However, instead of identifying a single component, the external component control system may identify multiple components that are the primary components, the components of focus, the active components, and/or the like. Accordingly, transmitting the instructions may include transmitting instructions to each of the components that have been identified as being the components to which the input is directed.

Another technique to make the determination regarding how many components that the input is to be directed towards may identifying particular information related to or contained within the input. For example, the user may provide input to the input element and also input to a modifier key at the same time. The external component control system may be programmed to recognize the addition of a modifier key as designating the input for more than one component. Different modifier keys may result in a different number of components being designated for the input. For example, a Shift key may result in the input being transmitted to two external components, whereas a Ctrl key may result in the input being transmitted to all external components. As another example, input provided using multiple modalities (e.g., text, mechanical, gesture, audio, image, video, haptic, etc.) may designate the input as being for more than one component. For example, input provided at the input element and audible input may indicate that the input is intended for more than one external component. Other techniques for designating the input for more than one component are contemplated and possible.

If more than one component is detected, then the system may control the characteristic of the components equally so that the output characteristic appears the same across the components, even if this means that the actual setting is not the same across the components. In other words, the increase or decrease in the characteristic for all the components will be the same or perceptively the same so that the resulting setting for the components will have a consistent appearance, even if the final settings are not the same values for the characteristics. For example, one display device may have the same brightness at 50% brightness as another display device at 70% brightness. Accordingly, the input may adjust the settings accordingly. These differences can be identified using the profile information, secondary sources which have information related to component specifications, based upon other user profiles, based upon settings that the components to which components have individually been set, and/or the like.

It will be readily understood that the components of the embodiments, as generally described and illustrated in the figures herein, may be arranged and designed in a wide variety of different configurations in addition to the described example embodiments. Thus, the more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

As will be appreciated by one skilled in the art, various aspects may be embodied as a system, method, or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Additionally, the term “non-transitory” includes all media except signal media.

Program code embodied on a storage medium may be transmitted using any appropriate medium, including but not limited to wireless, wireline, optical fiber cable, radio frequency, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices, and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

1. A method, the method comprising:
detecting, using an external component control system, input provided at an input element of a device, wherein the input element is configured to control a characteristic of an integral display component of the device;
determining, using the external component control system, that the input is to be directed to an external display component, thereby overriding control of the integral display component for the characteristic associated with the input element; and
transmitting, based upon the input provided to the input element, device-specific instructions to the selected external display component while suppressing any adjustment to the characteristic of the integral display component.

2. The method of claim 1, wherein the detecting the input comprises detecting a connection of the device to the external display component.

3. The method of claim 2, wherein the detecting the input comprises identifying, by accessing a user profile, a final setting for the characteristic of the external component based upon a previous connection session while the device was connected to the external display component; and
wherein the transmitting the instructions comprises generating instructions to adjust the characteristic of the external display component to match the final setting.

4. The method of claim 2, wherein the detecting the input comprises determining a setting for the characteristic of the external display component by inferring the setting for the characteristic from historical settings of the characteristic provided by other users of the external display component; and
wherein the transmitting the instructions comprises generating instructions to adjust the characteristic of the external display component to the setting.

5. The method of claim 1, wherein the determining comprises identifying that the external display component and the display component of the device are of a same component type, and identifying that the external display component is being used as a primary component as compared to the component of the device.

6. The method of claim 1, wherein the determining comprises identifying a focus of a user providing the input and correlating the focus to the external display component.

7. The method of claim 1, wherein the determining comprises identifying the external display component is an active external component.

8. The method of claim 1, comprising detecting a plurality of external components having a same type; and
wherein the transmitting the instructions comprises transmitting the instructions to each of the plurality of external components.

9. The method of claim 1, wherein the transmitting the instructions comprises transmitting, to the external display component, codes corresponding to the external display component and the characteristic.

10. The method of claim 1, wherein the external display component comprises a component selected from a group consisting of: a display device, an audio output device, an image capture device, or an audio capture device.

11. A system, the system comprising:
a device comprising an input element;
an external display component;
a processor;
a memory device that stores instructions that, when executed by the processor, causes the system to:
detect, using an external component control system, input provided at the input element of the device, wherein the input element is configured to control a characteristic of an integral display component of the device;
determine, using the external component control system, that the input is to be directed to an external display component, thereby overriding control of the integral display component for the characteristic associated with the input element; and
transmit, based upon the input provided to the input element, device-specific instructions to the selected external display component while suppressing any adjustment to the characteristic of the integral display component.

12. The system of claim 11, wherein the detecting the input comprises detecting a connection of the device to the external display component.

13. The system of claim 12, wherein the detecting the input comprises identifying, by accessing a user profile, a final setting for the characteristic of the external component based upon a previous connection session while the device was connected to the external display component; and
wherein the transmitting the instructions comprises generating instructions to adjust the characteristic of the external display component to match the final setting.

14. The system of claim 12, wherein the detecting the input comprises determining a setting for the characteristic of the external display component by inferring the setting for the characteristic from historical settings of the characteristic provided by other users of the external display component; and
wherein the transmitting the instructions comprises generating instructions to adjust the characteristic of the external display component to the setting.

15. The system of claim 11, wherein the determining comprises identifying that the external display component and the display component of the device are of a same component type, and identifying that the external display component is being used as a primary component as compared to the component of the device.

16. The system of claim 11, wherein the determining comprises identifying a focus of a user providing the input and correlating the focus to the external display component.

17. The system of claim 11, wherein the determining comprises identifying the external display component is an active external component.

18. The system of claim 11, comprising detecting a plurality of external components having a same type; and
wherein the transmitting the instructions comprises transmitting the instructions to each of the plurality of external components.

19. The system of claim 11, wherein the transmitting the instructions comprises transmitting, to the external display component, codes corresponding to the external display component and the characteristic.

20. A product, the product comprising:
a computer-readable storage device that stores executable code that, when executed by a processor, causes the product to:
detect, using an external component control system, input provided at an input element of a device, wherein the input element is configured to control a characteristic of an integral display component of the device;
determine, using the external component control system, that the input is to be directed to an external display component, thereby overriding control of the integral display component for the characteristic associated with the input element; and
transmit, based upon the input provided to the input element, device-specific instructions to the selected external display component while suppressing any adjustment to the characteristic of the integral display component.
